(19) United States
(12) Patent Application Publication
(10) Pub. No.: US 2017/0202197 A1
(43) Pub. Date: Jul. 20, 2017

(54) Fishing Rod Rest

(71) Applicant: David Wilson, Rye, NH (US)

(72) Inventor: David Wilson, Rye, NH (US)

(21) Appl. No.: 15/409,603

(22) Filed: Jan. 19, 2017

Related U.S. Application Data
(60) Provisional application No. 62/280,479, filed on Jan. 19, 2016.

(51) Int. Cl. A01K 97/10; A45F 5/02; A01K 99/00

(52) U.S. Cl. CPC A01K 97/10; A01K 99/00; A45F 5/021

(57) ABSTRACT

A multipurpose fishing rod rest that attaches to a fisherperson's clothing. The fishing rod rest allows the fisherperson to easily rest a fishing rod on their body and pull the fishing rod against their body without risk of injuring themselves or damaging their clothing that is portable and easy to use.

### CROSS REFERENCE TO RELATED APPLICATION

This application takes priority from and claims the benefit of U.S. Provisional Application Ser. No. 62/280,479 filed on Jan. 19, 2016, the contents of which are herein incorporated by reference.

### BACKGROUND OF THE INVENTION

1. Field of the Invention

The present system pertains to fishing rod accessories and more specifically to portable fishing rod rest to be worn on the user's body.

2. Description of the Related Prior Art

Fishing rods have been traditionally operated by being held vertically, pulled back behind the user and cast towards the water. Once a fish has grabbed hook the fisherperson operates the rod with their arms until the fish becomes fatigued enough to be reeled in. While hooking a fish the fisherperson may hold the fishing rod in his arms, rest the fishing rod on a device attached to the surrounding environment or rest the fishing rod against the fisherman's body. Securing the fishing rod on a device attached to the environment requires a specific environment that is compatible with the device and they are generally not portable. If a fisherperson chooses to hold the rod in their arms it is difficult to secure the base of the rod, which makes it difficult to pull back against the fish. If the fisherperson chooses to hold the base of the rod against their body they must undergo discomfort and run the risk of damaging their body or their clothing.

### SUMMARY OF THE INVENTION

The instant device, as illustrated herein, is clearly not anticipated, rendered obvious, or even present in any of the prior art mechanisms, either alone or in any combination thereof. A device for resting a fishing rod against a fisherperson's body while not in use is shown. Thus the several embodiments of the instant device are illustrated herein.

In its broadest interpretation, this disclosure describes a device for a fishing rod rest, a primary goal of which is to provide a fishing rod rest that overcomes the shortcomings of the concurrent art environmental fishing rod rests. It is yet another object of the present device to provide a fishing rod rest that is portably and easy to use.

Briefly stated, in one embodiment, the present device contemplates a fishing rod rest comprising a belt hook, a receiving hook and a guide notch.

An embodiment of the present device utilizes the belt hook to attach the device to their body, preferably to a belt attached to their pants. The user than places the bottom of a fishing rod on the ground and rests the fishing rod in the receiving hook and guide notch.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

There has thus been outlined, rather broadly, the more important features of the fishing rod rest in order that the detailed description thereof that follows may be better understood, and in order that the present contribution to the art may be better appreciated. There are additional features of the system that will be described hereinafter and which will form the subject matter of the claims appended hereto.

### BRIEF DESCRIPTION OF THE DRAWINGS

Advantages of the present system will be apparent from the following detailed description of exemplary embodiments thereof, which description should be considered in conjunction with the accompanying drawings, in which: Having thus described the system in general terms, reference will now be made to the accompanying drawings, which are not necessarily drawn to scale, and wherein:

FIG. 1 illustrates a side view of an embodiment of the fishing rod rest.

FIG. 2A illustrates a front view of an embodiment of the fishing rod rest.

FIG. 2B illustrates a read view of an embodiment of the fishing rod.

FIG. 3 illustrates front view of an embodiment of the fishing rod rest attached to a fisherperson's belt.

### DETAILED DESCRIPTION OF THE SEVERAL EMBODIMENTS

The detailed description set forth below in connection with the appended drawings is intended as a description of presently preferred embodiments of the system and does not represent the only forms in which the present system may be constructed and/or utilized. The description sets forth the functions and the sequence of steps for constructing and operating the system in connection with the illustrated embodiments.

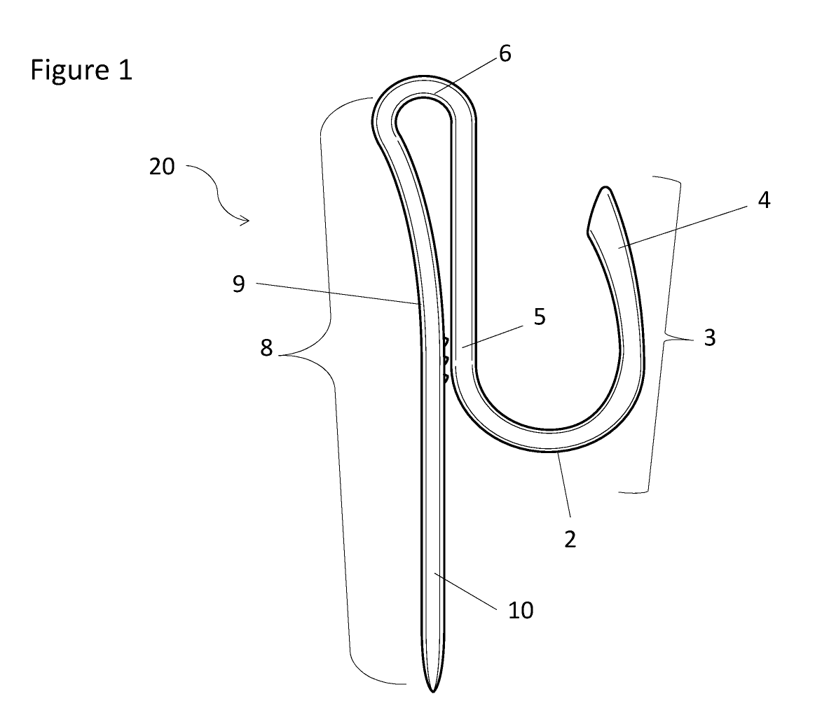

Turning now descriptively to the drawings, FIG. 1 illustrates a side view of an embodiment of the fishing rod rest 20. This embodiment of the fishing rod rest 20 has a belt hook 8 and a receiving hook 3. The belt hook 8 is comprised of a base segment 10 and a curved segment 6. In this embodiment of the device the base segment 10 is substantially straight, smooth, and has a slight bend in the middle 9, however in other embodiments the base segment 10 may be entirely straight, substantially bent or curved, or have a textured surface. At the top of the fishing rod rest 20 the belt hook 8 is comprised of a curved segment 6. The receiving hook 3 is comprised of a back segment 5, a curved segment 2, and a guide segment 4. In this embodiment the back segment 5 is substantially straight and smooth, however in other embodiments the back segment 5 may be curved or have a textured surface. In this embodiment the guide segment 4 is substantially straight and smooth, however in other embodiments the guide segment 4 may be may be entirely straight, substantially bent or curved, or have a textured surface.

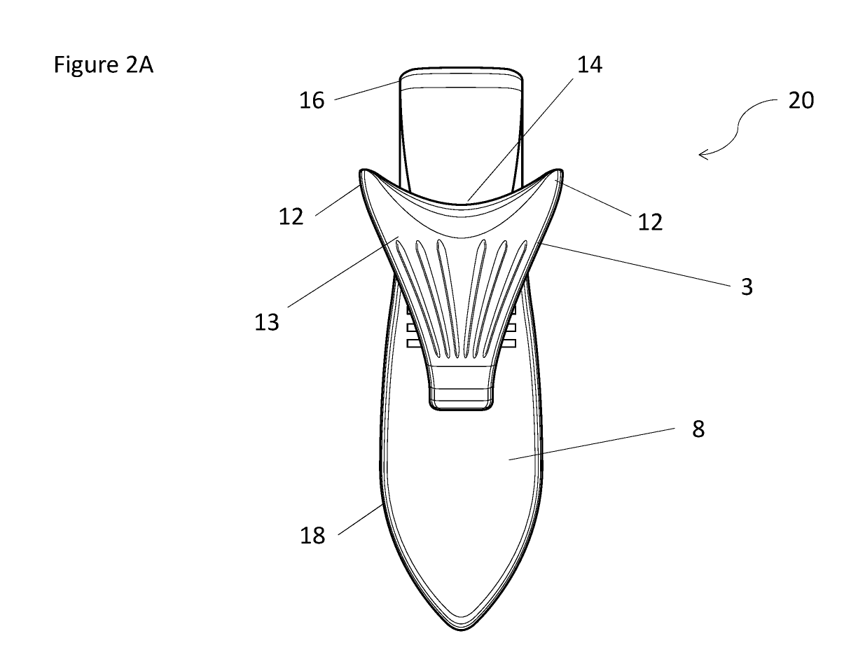

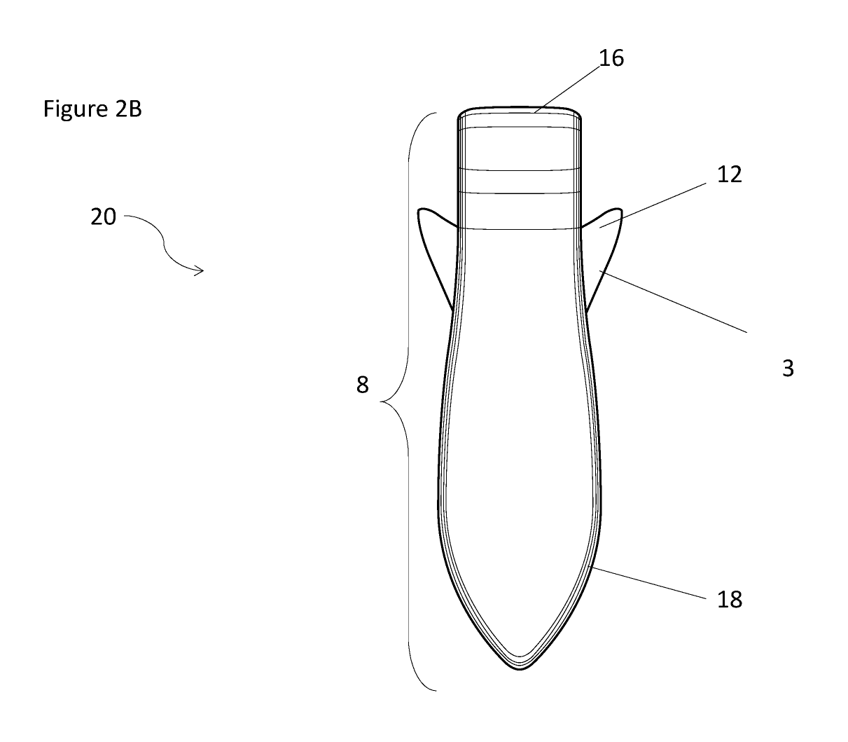

FIG. 2A illustrates a front view of an embodiment of a fishing rod rest 20. FIG. 2B illustrates a rear view of a similar embodiment of the fishing rod rest 20. In these figures, the fishing rod rest 20 is comprised of a belt hook 8, a receiving segment 3, and a guide notch 13. In this embodiment the belt hook 8 is has an ovoidal segment 18 at the bottom, however in other embodiments the belt hook 8 may be rectangular, triangular, or textured. The belt hook 8 extends below the receiving hook 3 and the top 16 of the belt hook 8 extends above the guiding notch 13. In this embodiment of the fishing rod rest 20 the guide notch 13 comprises two crests 12 and an indentation 14. In this embodiment the indentation 14 is substantially triangular, however in other embodiments the indentation may be rectangular, circular or textured.

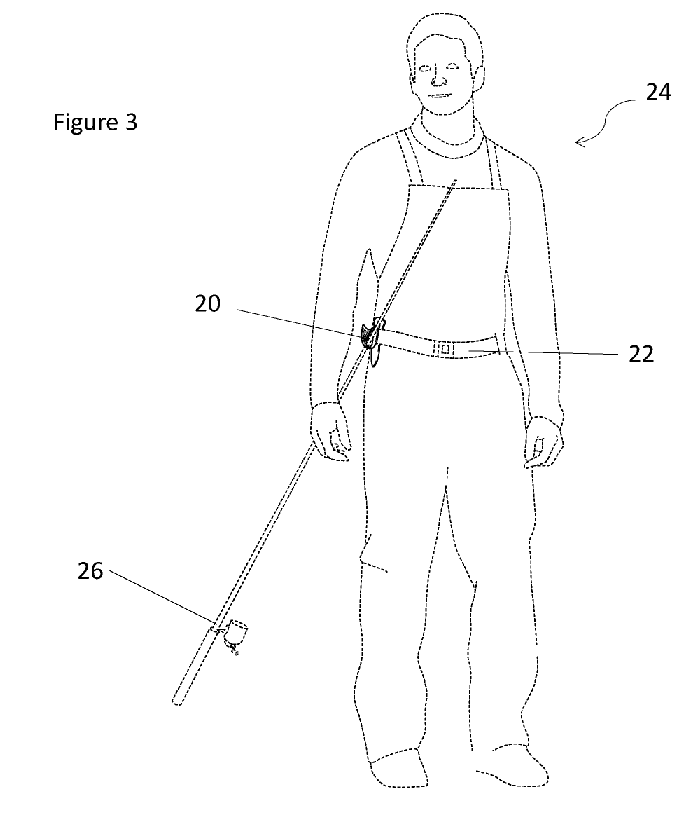

FIG. 3 illustrates a front view of a fisherperson 24 wearing a fishing rod rest 20 on their belt 22. In this embodiment the fisherperson 24 is wearing a fishing rod rest 20 on their belt 22, however in other embodiments a fishing rod rest 20 may be directly attached to a fisherperson's pants, shirt, or other article of clothing.

Herein, the fisherperson 24 is wearing the fishing rod rest 20 on their belt 22 with a fishing rod 26 resting in the fishing rod rest 20. When at rest the fisherperson 24 does not have to apply any force to the fishing rod 26 for the fishing rod 26 to stay in front of the fisherperson 24. This is particularly useful for when a fisherperson 24 needs to attach a hook to the rod or attach bait to a hook attached to the fishing rod 26.

In other embodiments, a fisherperson 24 may operate a fishing rod 26 that is rested by a fishing rod rest 20 on their belt 22. The fishing rod rest 20 allows the fisherperson 24 to pull back on the fishing rod 26, towards their body, without fear of injuring themselves or their clothing.

What is claimed is:

1. A fishing rod rest comprising:
a belt hook; and
a receiving hook.

2. The fishing rod rest of claim 1 wherein the belt hook comprises a base segment and a curved segment.

3. The fishing rod rest of claim 2 wherein the base segment comprises a slight indentation.

4. The fishing rod rest of claim 1 wherein entire surface of the rest is textured.

5. The fishing rod rest of claim 1 wherein the receiving hook comprises a back segment, a curved segment, and a guide segment.

6. The fishing rod rest of claim 1 further comprising a guide notch.

7. The fishing rod rest of claim 6 wherein the belt hook comprises a base segment and a curved segment.

8. The fishing rod rest of claim 7 wherein the base segment comprises a slight indentation.

9. The fishing rod rest of claim 6 wherein entire surface of the rest is textured.

10. The fishing rod rest of claim 6 wherein the receiving hook comprises a back segment and a curved segment.

11. The fishing rod of claim 6 wherein the guide notch comprises two crests and an indentation.

12. A method of operating a fishing rod comprising attaching a fishing rod rest to the fisherperson's clothing and placing a fishing rod in the fishing rod rest.

13. The method of operating a fishing rod of claim 12 wherein the fishing rod rest is attached to the fisherperson's belt.

14. A method of securing a fishing rod comprising attaching a fishing rod rest to the fisherperson's clothing and placing a fishing rod in the fishing rod rest.

15. The method of securing a fishing rod of claim 14 wherein the fishing rod rest is attached to the fisherperson's belt.
